(19) United States
(12) Patent Application Publication
(10) Pub. No.: US 2021/0057990 A1
(43) Pub. Date: Feb. 25, 2021

(54) DC/DC TRANSFORMER FOR POWER TRANSMISSION IN TELECOM APPLICATIONS

(71) Applicant: Flex Ltd., SINGAPORE (SG)

(72) Inventor: Yong Wang, Shanghai (CN)

(73) Assignee: Flex Ltd

(21) Appl. No.: 16/563,386

(22) Filed: Sep. 6, 2019

(30) Foreign Application Priority Data
Aug. 19, 2019 (CN) 201910763761.5

(51) Int. Cl. H02M 3/00; H02J 9/06

(52) U.S. Cl. CPC H02M 3/00; H04W 88/08; H02J 9/061

(57) ABSTRACT

A telecom base station has a main-remote structure, where the main unit can be a BBU and the remote unit can be a RRU. A power supply unit is configured to receive as input an AC voltage, such as main line AC voltage, and convert the input AC voltage to a DC voltage at a standardized DC voltage level required for operating standardized baseband equipment in the BBU. A step-up DC transformer converts the DC voltage output from the power supply unit to a high DC voltage level. A step-down DC transformer receives as input the high DC voltage output from the step-up DC transformer and outputs a stepped-down DC voltage level, which is supplied as input to the RRU.

### RELATED APPLICATIONS

This patent application claims priority of the co-pending Chinese patent application, Application Serial No. 201910763761.5, filed on Aug. 19, 2019, and entitled “DC/DC Transformer for Power Transmission in Telecom Applications”, which is hereby incorporated in its entirety by reference.

### FIELD OF THE INVENTION

The present invention is generally directed to power transmission and DC/DC transformers. More specifically, the present invention is directed to DC/DC transformers used for power transmission in telecom applications.

### BACKGROUND OF THE INVENTION

In the wireless telecommunications industry, a wireless telecommunications network includes many interconnected antenna structures referred to as radio base stations. In some configurations, the radio base station includes an antenna, which may be located on the top of a tower, mast, or top of building, and a RBS (radio base station) cabinet that houses a DC power supply system with battery backup, and telecommunications equipment, such as signal processing circuitry and network backbone interconnection. FIG. 1 illustrates an exemplary conventional radio base station structure that includes an antenna mast structure 4 and a RBS cabinet 6. The antenna mast structure 4 includes a mast 8 connected to a mast base 14 that is secured to ground. One or more antennas 10 are connected to a top of the mast 8. A tower mounted amplifier (TMA) 12 is connected to the antennas 10, and a RF (radio frequency) cable 16 connects the TMA 12 and antennas 10 to the RBS cabinet 6. The RF cable 16 and the TMA 12 are mounted to the mast 8. The RBS cabinet 6 includes signal processing circuitry and RF equipment to process telecommunications signals received from and provided to the TMA 12 and antennas 10. The RBS cabinet 6 also includes network access circuitry for interconnecting to a telecommunications network backbone. Telecommunications equipment, such as the RBS cabinet 6, is configured to operate at a standardized DC power level, for example −48V DC. The RBS cabinet 6 includes a DC battery backup. RF signaling is transmitted between the RBS cabinet 6 and the TMA 12/antennas 10 by the RF cable 16. It is well known that RF cable suffers from increasing signal attenuation with increasing cable length. In the case of the conventional radio base station configuration shown in FIG. 1, the length of the RF cable 16 is substantial, which results in significant signal attenuation between the antennas 10 and the RBS cabinet 6.

In other configurations, a main-remote structure is widely used for the physical structure of the radio base station. The main-remote structure essentially splits the RBS of the previous configurations into two separate components, a baseband unit (BBU) and a remote radio unit (RRU). In the main-remote structure, the RRU is mounted close to the antenna on top of the antenna tower, mast, or building and is connected to the antennas, and the BBU is a ground unit separate from the RRU. An advantage of the main-remote structure is that the telecommunications signaling is transmitted between the RRU and the BBU using fiber cable, also referred to as fiber optic cable, which does not suffer from signal attenuation over distance. FIG. 2 illustrates an exemplary conventional radio base station having a main-remote structure. The main-remote structure includes a BBU 20 and a RRU 22. The antenna tower structure includes the mast 8 connected to the mast base 14 that is secured to ground. The one or more antennas 10 are connected to the top of the mast 8. The RRU 22 is also mounted to the top of the mast 8 and is connected to the antennas 10. Fiber cable 24 and DC cable 26 connect the RRU 22 to the BBU 20. The RF cable 16 and the DC cable 26 are mounted to the mast 8. The RRU 22 processes telecommunications signals received from and provided to the antennas 10 and the BBU 20. The BBU 20 includes signal processing circuitry to process telecommunications signals received from and provided to the RRU 22. The BBU 20 also includes network access circuitry for interconnecting to a telecommunications network backbone. The antennas 10 are passive devices and do not require input power to operate. The BBU 20 and the RRU 22 are configured to operate at a standardized DC power level, for example −48V DC. DC power is supplied to the RRU 22 from the BBU 20 using DC cable 26. The RRU 22 and the BBU 20 each include a DC battery backup. Telecommunications signaling is provided between the BBU 20 and the RRU 22 by the fiber cable 24. The telecommunication signaling between the RRU 22 and the BBU 20 is serial high-speed digital data. In contrast, the telecommunication signaling between the antenna 10 and RBS cabinet 6 in FIG. 1 is an RF analog signal, which is not able to be transmitted using fiber optic cable. As such, RF cabling 16 is used in the main-remote structure 2 of FIG. 1, whereas fiber cabling 24 is used in the main-remote structure 18 of FIG. 2. It is a function of the RRU 22 to process RF signaling, and to convert to a digital signal for further processing by the BBU 20.

Although fiber cable does not suffer from signal attenuation over distance, cable that transmits DC power does suffer from increasing power loss with increasing cable length, and as such a voltage drop across such cable increases with increasing distance between a power supply and the end-user device in the main-remote structure. In typical configurations, the DC power supply is co-located with the BBU, so the primary source of power loss is in the DC cable that connects the DC power supply co-located with the BBU to the RRU. Power loss can be decreased by increasing a cross-sectional area of the DC cable. A maximum distance between the BBU and the RRU is limited by the cable size at specified DC power level and voltage condition. Although the cable size (cross-sectional area) can be increased to accommodate increased cable length, the cost and weight of the cable increases accordingly. FIG. 3 illustrates example calculations for the cable size needed for a given power consumption and voltage condition. As shown in the two example calculations, case 1 and case 2, a cable having a cross-sectional area of 1.3 mm² can have length of 20 m (case 2), whereas a cable having a cross-sectional area of 13.27 mm² can have a length of 200 m (case 1). The main reason for power loss is the current through the cable, as indicated by the formula P=I²R. As such, the power loss can be reduced by increasing the voltage according to the formula I=P/V.

Two alternative approaches are currently used to provide increased voltage over power supply cable. A first approach is to change the power supply from the standardized DC power supply level, for example −48V DC, to AC power. An advantage of using AC power is that it is readily available from the existing power grid infrastructure, for example the main AC line provided at each building. Another advantage is that there are a multitude of existing AC/DC power supply technologies and products. However, AC power supply backup systems, for example uninterruptible power supplies (UPS) with batteries, are much more expensive than DC power supply backup systems that include batteries.

FIG. 4 illustrates a schematic block diagram of an exemplary first AC power solution used in a conventional main-remote structure. The main-remote structure includes a power supply unit 30, a BBU 42, and an RRU 50. Although the power supply unit 30 and the BBU 42 are shown as separate units, the power supply unit and the BBU can be integrated as a single unit. The power supply unit 30 includes an AC-to-DC converter 32, a UPS 34, and a battery 36. The BBU 42 includes baseband equipment 44, such as signal processing circuitry for processing telecommunications signals received from and provided to the RRU 50 and network access circuitry for interconnecting to a telecommunications network backbone. The RRU 50 includes radio equipment 52 and an AC-to-DC converter 54. The radio equipment 52 processes telecommunications signals received from and provided to the antennas (not shown) and the BBU 42. A difference between radio equipment and baseband equipment is the type of signaling that is processed. Radio equipment processes RF analog signals and baseband equipment processes digital baseband signals. The power supply unit 30 is supplied with an input AC voltage 28, such as AC voltage from a main line. The input AC voltage 28 is input to the UPS 34, and a corresponding AC voltage is output from the UPS 34. The AC voltage output from the UPS is substantially the same AC voltage as input to the UPS 34. The AC voltage output from the UPS 34 is output from the power supply unit 30 as output AC voltage 40, which is passed through the BBU 42 and supplied as input to the AC-to-DC converter 54 of the RRU 50 via AC cable 48. AC cable is configured to better handle higher voltages than DC cable. The AC voltage output from the UPS 34 is also input to the AC-to-DC converter 32 to output a DC voltage level 38, such as −48V DC, required to operate the baseband equipment 44. The DC voltage level 38 is supplied to the baseband equipment 44. The AC-to-DC converter 54 converts the AC voltage input via the AC cable 48 to a DC voltage level, such as −48V DC, required to operate the radio equipment 52. Telecommunications signaling is transmitted between the baseband equipment 44 of the BBU 42 and the radio equipment 52 of the RRU 50 by fiber cable 46. This first AC solution uses a UPS and AC battery backup system that provides power to both the BBU and the RRU. In this case, there is no need for a separate local power supply backup in the RRU as power and power supply backup is provided for both the BBU and the RRU in the BBU. However, UPS and AC battery backup systems are expensive, considerably more expensive than comparable DC power backup systems. Also, since ES safety requirements are based on the physical product level, the radio equipment must be certified as ES3 hazard voltage safety level since it is included within the RRU 50, which has an input AC voltage over AC cable 48 of greater than 60V. The ES3 hazard voltage safety level results in more product design complexity and increased cost.

A second AC solution is used that does not use an UPS and AC battery backup system. Instead, separate DC battery backups are used in the BBU and in the RRU. FIG. 5 illustrates a schematic block diagram of an exemplary second AC power solution used in a conventional main-remote structure. The second AC solution is similar to the first AC solution shown in FIG. 4 except that the UPS 34 and AC battery backup system 36 in the BBU are replaced by a DC battery backup 60, and a separate DC battery backup 76 is included in the RRU. Specifically, the main-remote structure of FIG. 5 includes a DC power supply unit 56, a BBU 64, and an RRU 70. Although the DC power supply unit 56 and the BBU 64 are shown as separate units, the DC power supply unit and the BBU can be integrated as a single unit. The DC power supply unit 56 includes an AC-to-DC converter 58 and a DC battery backup 60. The BBU 64 includes baseband equipment 66, such as signal processing circuitry for processing telecommunications signals received from and provided to the RRU 70 and network access circuitry for interconnecting to a telecommunications network backbone. The RRU 70 includes an AC-to-DC converter 72, radio equipment 74, and a DC battery backup 76. The radio equipment 74 processes telecommunications signals received from and provided to the antennas (not shown) and the BBU 64. The DC power supply unit 56 is supplied with the input AC voltage 28, such as AC voltage from a main line. The input AC voltage 28 is input to the AC-to-DC converter 58 to output a DC voltage level 62, such as −48V DC, required to operate the baseband equipment 66. The DC voltage level 62 is supplied to the baseband equipment 66. The DC battery backup 60 provides a DC power backup to the baseband equipment 66 in the event that input AC voltage 28 is interrupted. Telecommunications signaling is transmitted between the baseband equipment 66 of the BBU 64 and the radio equipment 74 of the RRU 70 by fiber cable 68. The input AC voltage 28 is also supplied as input to the AC-to-DC converter 72 in the RRU 70. The input AC voltage 28 supplied to the AC-to-DC converter 72 can be from a separate connection to the main line than the input AC voltage 28 supplied to the AC-to-DC converter 58, or the input AC voltage 28 supplied to the AC-to-DC converter 72 can be supplied from the same connection as the input AC voltage 28 supplied to the AC-to-DC converter 58 where the input AC voltage 28 is passed through the DC power supply 56/BBU 64 and supplied to the RRU 70 via an AC cable (not shown) that connects the BBU 64 and the RRU 70. The AC-to-DC converter 72 converts the input AC voltage 28 to a DC voltage level, such as −48V DC, required to operate the radio equipment 74. The DC battery backup 76 provides a DC power backup to the radio equipment 74 in the event that input AC voltage 28 is interrupted. The second AC solution eliminates the need for expensive UPS and AC battery backup system. However, the DC battery backup in the RRU may have issues due to temperature, since batteries are temperature sensitive. The RRU is located outdoors and possible outdoor conditions may range from temperatures between −40° C. and +55° C. Batteries may experience negative operating issues below −10° C., and high temperatures negatively impact battery lifetimes. Also, the radio equipment must be certified as ES3 hazard voltage safety level, which results in product design complexity and increased cost.

A second approach for providing increased voltage over power supply cables is to change the power supply from the standardized DC power supply level, for example −48V DC, to a higher DC power supply level, for example 400V DC. Using this second approach, the input AC voltage is converted to a high DC voltage, and the high DC voltage is supplied to the baseband equipment in the BBU and transmitted from the BBU to the radio equipment in the RRU using a high voltage DC cable. FIG. 6 illustrates a schematic block diagram of an exemplary high voltage DC (HVDC) power solution used in a conventional main-remote structure. The main-remote structure includes a HVDC power supply unit 78, a BBU 86, and an RRU 94. Although the HVDC power supply unit 78 and the BBU 86 are shown as separate units, the HVDC power supply unit and the BBU can be integrated as a single unit. The HVDC power supply unit 78 includes an AC-to-DC converter 80 and a HVDC battery backup 82. The BBU 86 includes baseband equipment 88, such as signal processing circuitry for processing telecommunications signals received from and provided to the RRU 94 and network access circuitry for interconnecting to a telecommunications network backbone. The RRU 94 includes a DC-to-DC converter 96 and radio equipment 98. The radio equipment 98 processes telecommunications signals received from and provided to the antennas (not shown) and the BBU 86. The HVDC power supply unit 78 is supplied with an input AC voltage 28, such as AC voltage from a main line. The input AC voltage 28 is input to AC-to-DC converter 80 which converts the input AC voltage 28 to a high DC voltage level 84, such as 400V DC. The high DC voltage level 84 is supplied to the baseband equipment 88. The high DC voltage level 84 is greater than typical standardized DC power levels used to operate most baseband equipment. As such, the baseband equipment 88 must be customized to operate at the higher DC voltage level. The HVDC battery backup 82 provides a HVDC power backup to the baseband equipment 88 in the event that input AC voltage 28 is interrupted. The high DC voltage level 84 is also supplied to the DC-to-DC converter 96 in the RRU 94 by a HVDC cable 92. The high DC voltage level 84 can be passed to the HVDC cable 92 via the baseband equipment 88, as shown in FIG. 6, or by bypassing the baseband equipment 88. The DC-to-DC converter 96 converts the high DC voltage input via the HVDC cable 92 to a standardized, lower DC voltage level, such as −48V DC, required to operate the radio equipment 98. Telecommunications signaling is provided between the baseband equipment 88 of the BBU 86 and the radio equipment 98 of the RRU 94 by fiber cable 90. This second approach minimizes DC power transmission losses by transmitting at the high DC voltage level, eliminates the need for a UPS and AC battery backup system, and eliminates the need for a DC battery backup in the outdoor located RRU. However, most installation bases already have baseband equipment configured to operate at the standardized, lower DC power level. Using customized baseband equipment configured to operate at the high DC power level is a costly investment. Also, the radio equipment must be certified as ES3 hazard voltage safety level, which results in product design complexity and increased cost.

### SUMMARY OF THE INVENTION

Embodiments are directed to a telecom base station having a main-remote structure. In some embodiments, the main unit is a BBU and the remote unit is a RRU. A DC power supply unit can be integrated as part of the main unit or the power supply unit can be a separate unit that is co-located with the main unit. The DC power supply unit is configured to receive as input an AC voltage, such as main line AC voltage, and convert the input AC voltage to a DC voltage at a standardized DC voltage level required for operating standardized baseband equipment in the BBU. The main-remote structure includes a step-up DC transformer that receives as input the DC voltage output from an AC-to-DC converter in the DC power supply unit and converts same to a high DC voltage level. The step-up DC transformer can be integrated as part of the DC power supply unit or the step-up DC transformer can be a separate unit that is co-located with the DC power supply unit. The main-remote structure also includes a step-down DC transformer that receives as input the high DC voltage output from the step-up DC transformer and outputs a stepped-down DC voltage level, which is a DC voltage level suitable for operation of radio equipment in the RRU. The step-down DC transformer can be integrated as part of the RRU or the step-down DC transformer can be a separate unit that is co-located with the RRU. The high DC voltage is transmitted from the step-up DC transformer to the step-down DC transformer by a DC cable. Telecommunications signaling is transmitted between the BBU and the RRU by a fiber cable.

In an aspect, a telecom base station in a telecommunications network is disclosed. The telecom base station comprises a baseband unit powered by a first DC voltage having a first DC voltage level; a remote unit coupled to the baseband unit, wherein the remote unit is powered by a second DC voltage having a second DC voltage level, further wherein the baseband unit and the remote unit are configured to communicate telecommunications signals between each other; an antenna coupled to the remote unit; a DC power supply unit coupled to the baseband unit and configured to receive as input an AC voltage and to output the first DC voltage; a step-up DC transformer coupled to the DC power supply unit and configured to receive as input the first DC voltage and to output a high DC voltage having a high DC voltage level that is greater than the first DC voltage level and greater than the second DC voltage level; and a step-down DC transformer coupled to the step-up DC transformer and the remote unit, and configured to receive as input the high DC voltage and to output a stepped-down DC voltage having a stepped-down DC voltage level, wherein the remote unit is further configured to receive the stepped-down DC voltage for powering the remote unit. In some embodiments, the baseband unit comprises a first telecommunications equipment configured for processing the telecommunications signals, further wherein the first telecommunications equipment is powered by the first DC voltage. In some embodiments, the first telecommunications equipment is a first standardized telecommunications equipment configured to operate at a first standardized DC voltage level, and the first standardized DC voltage level is the first DC voltage level output from the DC power supply unit. In some embodiments, the remote unit comprises a second telecommunications equipment, and the second telecommunications equipment is powered by the second DC voltage. In some embodiments, the second telecommunications equipment is a second standardized telecommunications equipment configured to operate at a second standardized DC voltage level, and the second standardized DC voltage level is the second DC voltage level. In some embodiments, the baseband unit comprises baseband equipment, further wherein the remote unit comprises a remote radio unit having radio equipment. In some embodiments, the DC power supply unit comprises a DC battery backup configured to output a backup DC voltage having a backup DC voltage level equal to the first DC voltage level. In some embodiments, the DC power supply unit comprises an AC-to-DC converter configured to receive as input the AC voltage and to output the first DC voltage. In some embodiments, the baseband unit is coupled to the remote unit by a fiber cable, and the telecommunications signals are communicated between the baseband unit and the remote unit via the fiber cable. In some embodiments, all power supplied to the remote unit is provided via the step-down DC transformer.

In another aspect, another telecom base station in a telecommunications network is disclosed. The telecom base station comprises a baseband unit comprising first telecommunications equipment configured for processing telecommunications signals, wherein the first telecommunications equipment is powered by a first DC voltage having a first DC voltage level; a remote unit coupled to the baseband unit and comprising second telecommunications equipment, wherein the second telecommunications equipment is powered by a second DC voltage having a second DC voltage level, further wherein the telecommunications signals are communicated between the first telecommunications equipment and the second telecommunications equipment; an antenna coupled to the remote unit; a DC power supply unit coupled to the baseband unit and configured to receive as input an AC voltage and to output the first DC voltage; a step-up DC transformer coupled to the DC power supply unit and configured to receive as input the first DC voltage and to output a high DC voltage having a high DC voltage level that is greater than the first DC voltage level and greater than the second DC voltage level; and a step-down DC transformer coupled to the step-up DC transformer and the remote unit, and configured to receive as input the high DC voltage and to output a stepped-down DC voltage having a stepped-down DC voltage level, wherein the remote unit is further configured to receive the stepped-down DC voltage for powering the second telecommunications equipment. In some embodiments, the first telecommunications equipment comprises baseband equipment, and the second telecommunications equipment comprises radio equipment. In some embodiments, the first telecommunications equipment is a first standardized telecommunications equipment configured to operate at a first standardized DC voltage level, and the second telecommunications equipment is a second standardized telecommunications equipment configured to operate at a second standardized DC voltage level, wherein the first standardized DC voltage level is the first DC voltage level output from the DC power supply unit, and the second standardized DC voltage level is the second DC voltage level. In some embodiments, the DC power supply unit comprises a DC battery backup configured to output a backup DC voltage having a backup DC voltage level equal to the first DC voltage level. In some embodiments, the DC power supply unit comprises an AC-to-DC converter configured to receive as input the AC voltage and to output the first DC voltage. In some embodiments, the first telecommunications equipment is coupled to the second telecommunications equipment by a fiber cable, and the telecommunications signals are communicated between the first telecommunications equipment and the second telecommunications equipment via the fiber cable. In some embodiments, all power supplied to the remote unit is provided via the step-down DC transformer.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 illustrates an exemplary conventional radio base station structure that includes an antenna mast structure 4 and a RBS cabinet 6.

FIG. 2 illustrates a conventional radio base station having a main-remote structure.

FIG. 3 illustrates example calculations for the cable size needed for a given power consumption and voltage condition.

FIG. 4 illustrates a schematic block diagram of an exemplary first AC power solution used in a conventional main-remote structure.

FIG. 5 illustrates a schematic block diagram of an exemplary second AC power solution used in a conventional main-remote structure.

FIG. 6 illustrates a schematic block diagram of an exemplary high voltage DC (HVDC) power solution used in a conventional main-remote structure.

FIG. 7 illustrates a schematic block diagram of a high voltage DC (HVDC) power solution used in a telecom base station according to some embodiments.

FIG. 8 illustrates a schematic functional block diagram of the step-up DC transformer and the step-down DC transformer according to some embodiments.

FIG. 9 illustrates various exemplary parameter values associated with conventional radio base station structure and a main-remote structure using the step-up and step down DC transformers to transmit high DC voltage between the power supply and the RRU.

### DETAILED DESCRIPTION OF THE EMBODIMENTS

Embodiments of the present application are directed to a telecom base station. Those of ordinary skill in the art will realize that the following detailed description of the telecom base station is illustrative only and is not intended to be in any way limiting. Other embodiments of the telecom base station will readily suggest themselves to such skilled persons having the benefit of this disclosure.

Reference will now be made in detail to implementations of the telecom base station as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

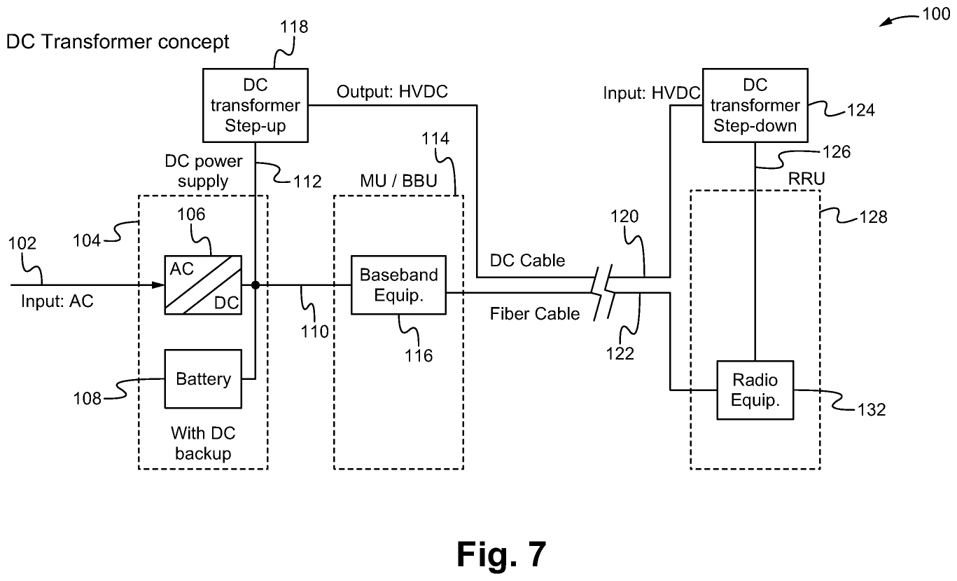

The telecom base station having a main-remote structure uses a step-up DC transformer and a step-down DC transformer to transmit power at a high DC voltage for powering the remote unit. The step-up DC transformer converts a standardized DC voltage level, for example −48V DC, used to power standardized baseband equipment in the BBU to a higher DC voltage level, for example 400V DC. It is understood that other standardized DC voltage levels are applicable. It is also understood that the higher DC voltage level can be less than or greater than 400V DC depending on the application, such as a distance between the step-up DC transformer and the step-down DC transformer. Power at the higher DC voltage level is transmitted from the step-up DC transformer to the step-down DC transformer co-located or proximate to the RRU. The step-down DC transformer converts the high DC voltage back to the standardized DC voltage, or to another standardized DC voltage level, which is used to power the radio equipment, or other telecom equipment, located in the RRU. The BBU can be mounted at ground level, and the RRU can be mounted on the top of a mast, tower, or building proximate one or more antennas. The step-up DC transformer can be positioned at ground level proximate to or co-located with the BBU, and the step-down DC transformer can be mounted proximate to or co-located with the RRU. FIG. 7 illustrates a schematic block diagram of a high voltage DC (HVDC) power solution used in a telecom base station according to some embodiments. In some embodiments, the telecom base station has a main-remote structure. The main-remote structure 100 includes a DC power supply unit 104, a BBU 114, and an RRU 128. Although the DC power supply unit 104 and the BBU 114 are shown as separate units, the DC power supply unit and the BBU can be integrated as a single unit. In some embodiments, the BBU is part of a RBS cabinet. The main-remote structure 100 also includes a step-up DC transformer 118 and a step-down DC transformer 124. Although the step-up DC transformer 118 and a step-down DC transformer 124 are shown as separate units, the step-up DC transformer and the DC power supply unit can be integrated as a single unit. In the case where the DC power supply unit and the BBU are integrated as a single unit, the step-up DC transformer can be a separate unit from the integrated DC power supply and BBU, or the step-up DC transformer, the DC power supply unit, and the BBU can be integrated as a single unit. Similarly, the step-down DC transformer and the RRU can be integrated as a single unit. When configured as separate units, such as shown in FIG. 7, the DC power supply unit 104 can be connected to the step-up DC transformer 118 by DC cable 112 to provide DC power from the DC power supply unit 104 to the step-up DC transformer 118, the DC power supply unit 104 can be connected to the BBU 114 by DC cable 110 to provide DC power from the DC power supply unit 104 to the BBU 114, and the step-down DC transformer 124 can be connected to the RRU 128 by DC cable 126 to provided DC power from the step-down DC transformer 124 to the RRU 128. The step-up DC transformer 118 is connected to the step-down DC transformer 124 by DC cable 120 configured to transmit high DC voltage.

The DC power supply unit 104 includes an AC-to-DC converter 106 and a DC battery backup 108. The BBU 114 includes baseband equipment 116, such as signal processing circuitry for processing telecommunications signals received from and provided to the RRU 128 and network access circuitry for interconnecting to a telecommunications network backbone. The RRU 128 includes radio equipment 132 with standardized DC voltage input, for example −48V DC. The radio equipment 132 processes telecommunications signals received from and provided to the antennas (not shown) connected to the RRU 128 and the BBU 114. It is understood that the baseband equipment 116 and the radio equipment 132 can include other components and circuitry including, but not limited to, noise and EMI filtering, power processing circuitry, and surge protection circuitry used in the normal operation of baseband and radio equipment. Although described herein as radio equipment, it is understood that in alternative embodiments the block 132 can be representative of other types of standardized telecom equipment having corresponding standardized functionality and power supply requirements. The DC power supply unit 104 is supplied with an input AC voltage 102, such as AC voltage from a main line. The input AC voltage 102 is input to the AC-to-DC converter 106 which converts the input AC voltage 102 to a DC voltage level suitable for operating the baseband equipment 116 in the BBU 114. In some embodiments, the baseband equipment 116 is equipment configured to operate according to a standardized DC voltage level, and the DC voltage level output from the AC-to-DC converter 106 is the standardized DC voltage level, such as −48V DC. The DC battery backup 108 provides a DC power backup to the baseband equipment 116 and to the step-up DC transformer 118 in the event that input AC voltage 102 is interrupted. The DC voltage level output from the DC battery backup 108 is the same DC voltage level output from the AC-to-DC converter 106.

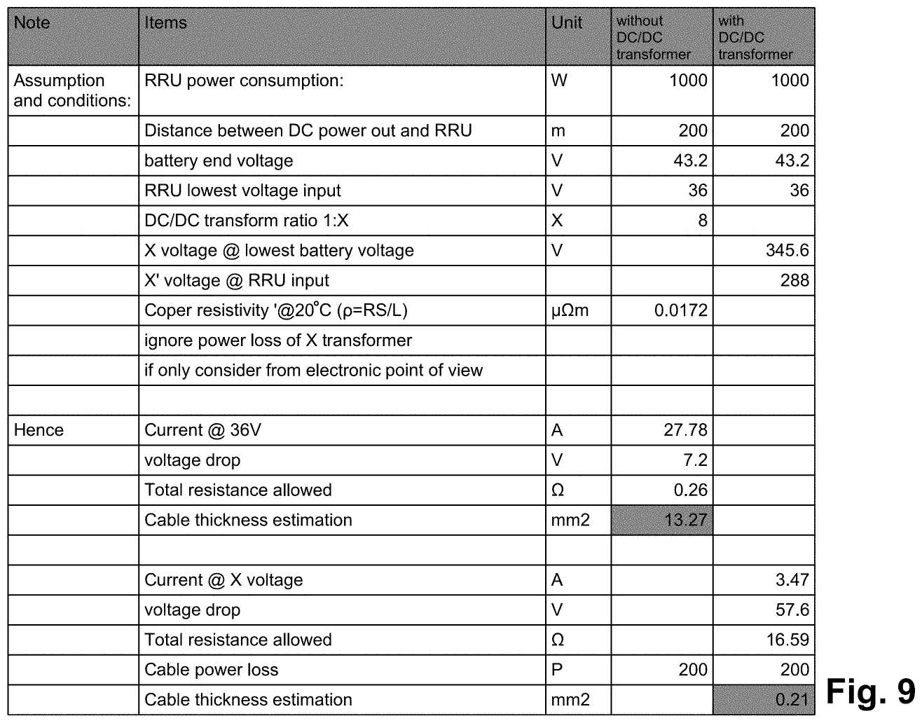

The step-up DC transformer 118 is configured to receive as input the DC voltage output from the AC-to-DC converter 106 and supplied to the step-up DC transformer 118 via the DC cable 112, and to step-up the input DC voltage to a high DC voltage, which is output to the DC cable 120. The step-up DC transformer 118 and the corresponding voltage level of the stepped-up high DC voltage output from the step-up DC transformer 118 can be designed to meet the application-specific requirements of a given main-remote structure. For example, a given main-remote structure has a designed physical distance separation between the main unit (BBU) and the remote unit (RRU) and a designed length and size (diameter) of DC cable 120 between the step-up DC transformer 118 and the step-down DC transformer 124. There may also be minimum voltage requirements of the input high DC voltage received by the step-down DC transformer 124. Since there is power loss over the DC cable 120 due to the cable size and length, even at the stepped-up high DC voltage level, the high DC voltage level received at the input of the step-down DC transformer 124 is less than the stepped-up high DC voltage output from the step-up DC transformer 118. The stepped-up high DC voltage output from the step-up DC transformer 118 can be configured to a voltage level that meets design requirements for the input high DC voltage received by the step-down DC transformer 124 accounting for power loss over the DC cabling 120, as well as accommodating the designed cable size and length, an example application of which is shown in FIG. 9.

The high DC voltage input to the step-down DC transformer 124 is stepped-down to a lower DC voltage level. The stepped-down DC voltage output from the step-down DC transformer 124 is input to radio equipment 132 via the DC cable 126. In some embodiments, the DC voltage level output from the step-down DC transformer 124 is a standardized DC voltage level, such as −48V DC, required to operate the radio equipment 132. Telecommunications signaling is transmitted between the BBU 114 and the radio equipment 132 of the RRU 128 by fiber cable 122. In an exemplary application, radio frequency signals are received/transmitted by one or more antennas (not shown) connected to the RRU 128. The radio equipment 132 demodulates received radio frequency signals to corresponding baseband signals, which are transmitted to the baseband equipment 116 by fiber cable 122. The radio equipment 132 also modulates baseband signals received from the baseband equipment 116, via fiber cable 122, and modulates the received baseband signals to radio frequency signals to be transmitted by the one or more antennas.

Although the BBU 114 is described above as including baseband equipment and the RRU 128 is described above as using radio equipment, it is understood that other types of telecommunications equipment, operating in alternative frequency bands, can be used in either the BBU or the RRU.

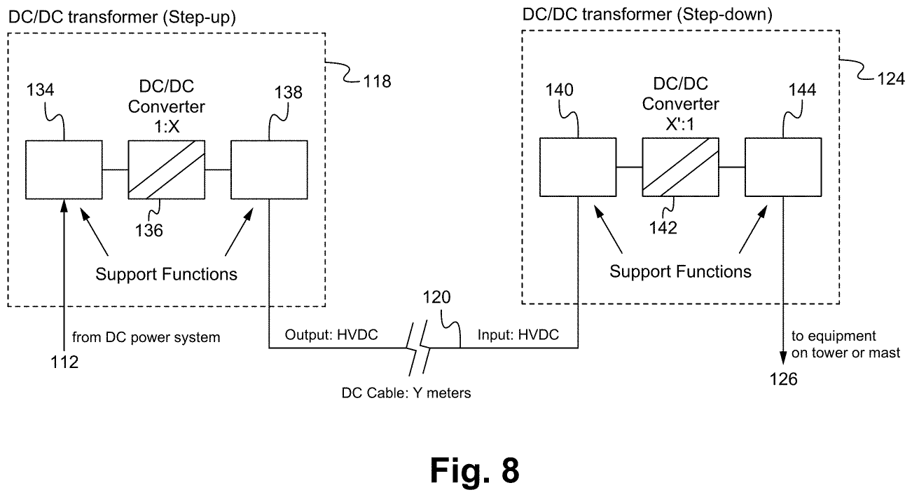

The step-up DC transformer 118 and the step-down DC transformer 124 each include support function circuitry and a DC-to-DC converter. In some embodiments, the DC-to-DC converter includes an LLC converter. In other embodiments, other types of DC-to-DC converters can be used including, but not limited to, hard switch full bridge converters, phase shift full bridge converters, and half bridge converters. The support function circuitry includes, but is not limited to, a fuse, surge protection circuitry, EMI filtering circuitry, and current leakage protection circuitry. FIG. 8 illustrates a schematic functional block diagram of the step-up DC transformer and the step-down DC transformer according to some embodiments. The step-up DC transformer 118 includes a DC-to-DC converter 136 and support function circuitry connected to one or both of an input side and an output side of the DC-to-DC converter 136. The DC-to-DC converter 136 is configured to output a higher DC voltage than the input DC voltage 112. Support function circuitry on the input side of the DC-to-DC converter 136 is collectively shown as support function circuitry block 134, and support function circuitry on the output side of the DC-to-DC converter 136 is collectively shown as support function circuitry block 138. In an exemplary application, the support function circuitry block 134 includes surge protection circuitry and EMI filtering circuitry, and the support function circuitry block 138 includes a fuse, current leakage protection circuitry, and surge protection circuitry. It is understood that the support function circuitry block 134 and the support function circuitry block 138 can include different combinations of support function circuitry. The step-down DC transformer 124 includes a DC-to-DC converter 142 and support function circuitry connected to one or both of an input side and an output side of the DC-to-DC converter 142. The DC-to-DC converter 142 is configured to output a lower DC voltage than the high DC voltage input to the step-down DC transformer 124 via the DC cable 120. Support function circuitry on the input side of the DC-to-DC converter 142 is collectively shown as support function circuitry block 140, and support function circuitry on the output side of the DC-to-DC converter 142 is collectively shown as support function circuitry block 144. In an exemplary application, the support function circuitry block 140 includes surge protection circuitry and EMI filtering circuitry, and the support function circuitry block 144 includes a fuse, current leakage protection circuitry, and surge protection circuitry. It is understood that the support function circuitry block 140 and the support function circuitry block 144 can include different combinations of support function circuitry.

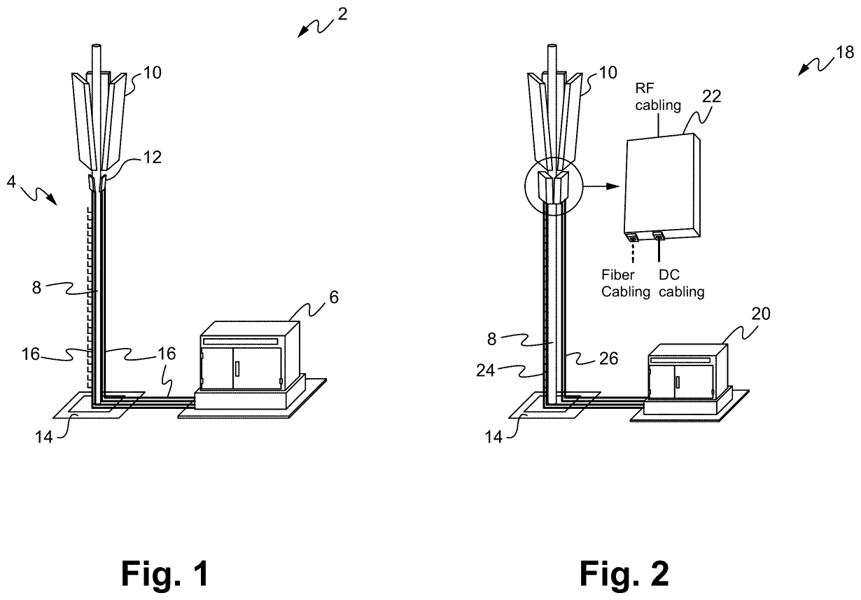

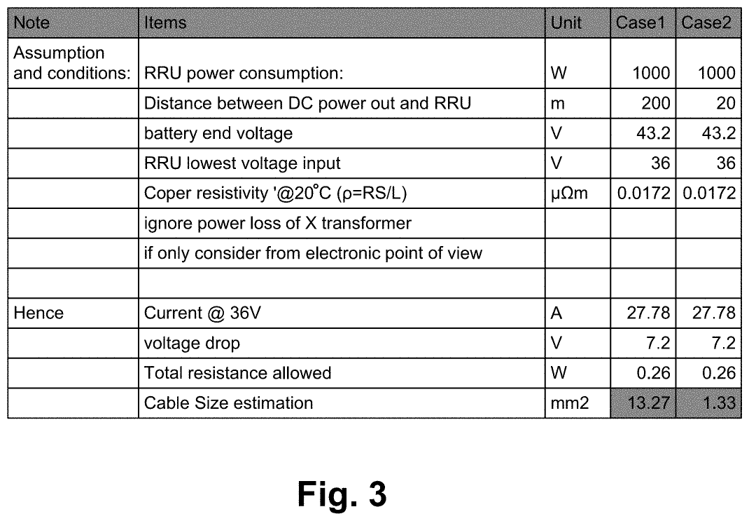

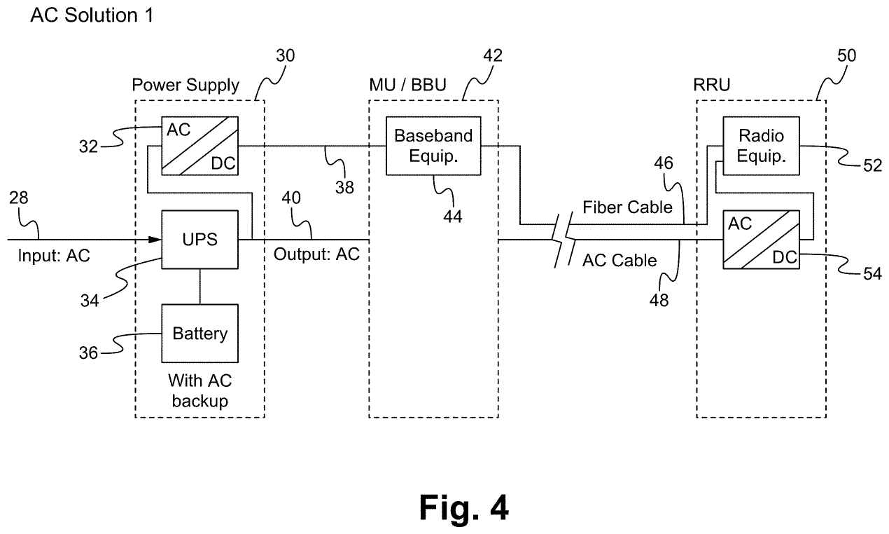

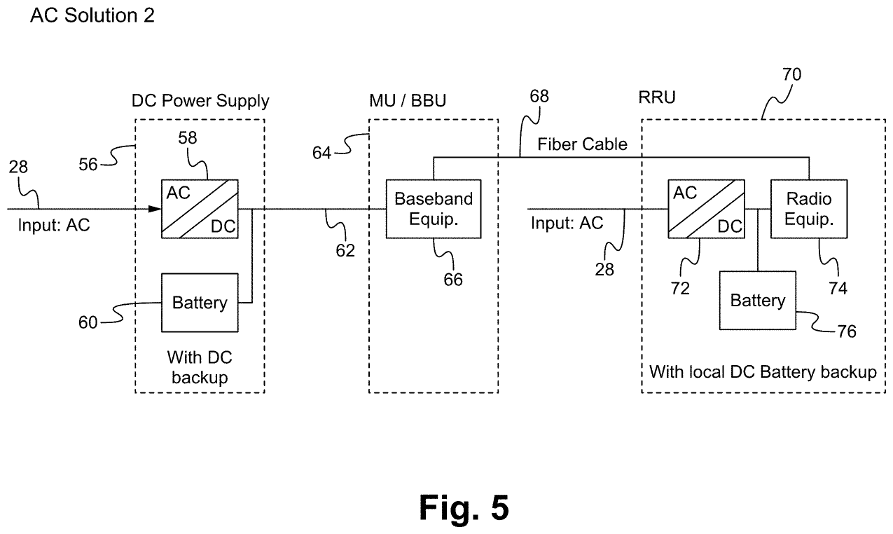

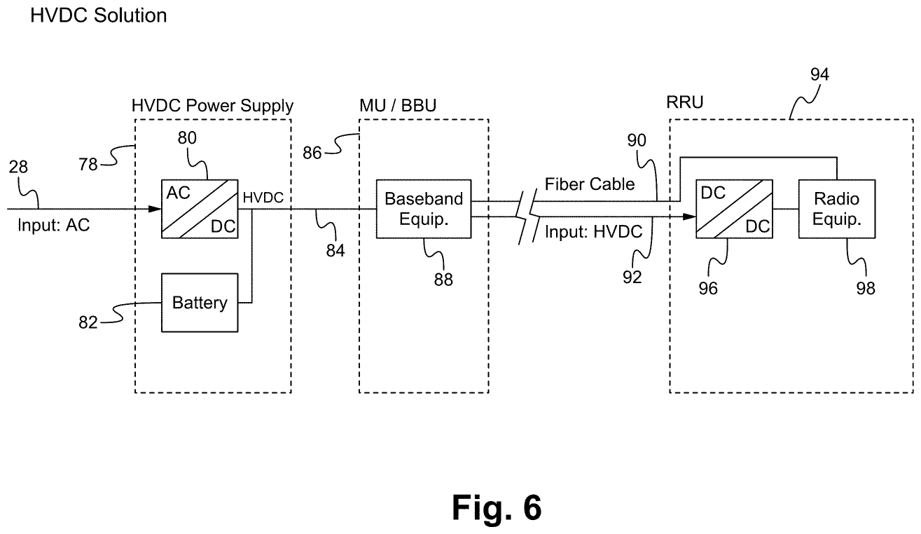

As described above, the voltage level for the high DC voltage is dependent, in part, on the size and length of the DC cable 120 connecting the step-up DC transformer 118 and the step-down DC transformer 124. FIG. 9 illustrates various exemplary parameter values associated with conventional radio base station structure and a main-remote structure using the step-up and step down DC transformers to transmit high DC voltage between the power supply and the RRU. The values of the various parameters corresponding to the conventional radio base station structure are shown in the column labeled “without DC/DC transformer”, and this structure corresponds to the conventional radio base station structure shown in FIG. 1. The values of the various parameters corresponding to the main-remote structure using the step-up and step down DC transformers are shown in the column labeled “with DC/DC transformer”, and this structure corresponds to the main-remote structure shown in FIG. 7. As shown in the two example calculations, without DC/DC transformer and with DC/DC transformer, the conventional radio base station structure with a cable length of 200 m requires a cable having a cross-sectional area of 13.27 mm², whereas the main-remote structure using the step-up and step down DC transformers and having the same cable length of 200 m only requires a cable to have a cross-sectional area of 0.21 mm². This can be further compared to the conventional main-remote structure shown in FIG. 2 and detailed as case 2 in FIG. 3, where a configuration having a 200 m cable length requires a cable having a cross-sectional area of 13.3 mm².

The telecom base station having a main-remote structure that uses a step-up DC transformer and a step-down DC transformer minimizes DC power transmission losses, reduces DC cable size, and/or increases the distance of power transmission between the DC power supply and DC power users, for example the distance between the BBU and the RRU, by transmitting power at the high DC voltage level. The telecom base station also operates with a DC battery backup located at the DC power supply unit, which provides DC power backup for both the BBU and the RRU, and eliminates the need for a DC battery backup in the outdoor located RRU. The telecom base station also enables the use of standardized baseband equipment and radio equipment that operates at standardized DC voltage levels, no new investment is necessary for customized equipment that operates at high DC voltage levels.

The present application has been described in terms of specific embodiments incorporating details to facilitate the understanding of the principles of construction and operation of the telecom base station. Many of the components shown and described in the various figures can be interchanged to achieve the results necessary, and this description should be read to encompass such interchange as well. As such, references herein to specific embodiments and details thereof are not intended to limit the scope of the claims appended hereto. It will be apparent to those skilled in the art that modifications can be made to the embodiments chosen for illustration without departing from the spirit and scope of the application.

1. A telecom base station in a telecommunications network comprising:
a. a baseband unit powered by a first DC voltage having a first DC voltage level;
b. a remote unit coupled to the baseband unit, wherein the remote unit is powered by a second DC voltage having a second DC voltage level, further wherein the baseband unit and the remote unit are configured to communicate telecommunications signals between each other;
c. an antenna coupled to the remote unit;
d. a DC power supply unit coupled to the baseband unit and configured to receive as input an AC voltage from an AC voltage source external to the telecom base station and to output the first DC voltage;
e. a step-up DC transformer coupled to the DC power supply unit and configured to receive as input the first DC voltage and to output a high DC voltage having a high DC voltage level that is greater than the first DC voltage level and greater than the second DC voltage level; and
f. a step-down DC transformer coupled to the step-up DC transformer and the remote unit, and configured to receive as input the high DC voltage and to output a stepped-down DC voltage having a stepped-down DC voltage level, wherein the remote unit is further configured to receive the stepped-down DC voltage for powering the remote unit.

2. The telecom base station of claim 1 wherein the baseband unit comprises a first telecommunications equipment configured for processing the telecommunications signals, further wherein the first telecommunications equipment is powered by the first DC voltage.

3. The telecom base station of claim 2 wherein the first telecommunications equipment is a first standardized telecommunications equipment configured to operate at a first standardized DC voltage level, and the first standardized DC voltage level is the first DC voltage level output from the DC power supply unit.

4. The telecom base station of claim 1 wherein the remote unit comprises a second telecommunications equipment, and the second telecommunications equipment is powered by the second DC voltage.

5. The telecom base station of claim 4 wherein the second telecommunications equipment is a second standardized telecommunications equipment configured to operate at a second standardized DC voltage level, and the second standardized DC voltage level is the second DC voltage level.

6. The telecom base station of claim 1 wherein the baseband unit comprises baseband equipment, further wherein the remote unit comprises a remote radio unit having radio equipment.

7. The telecom base station of claim 1 wherein the DC power supply unit comprises a DC battery backup configured to output a backup DC voltage having a backup DC voltage level equal to the first DC voltage level.

8. The telecom base station of claim 1 wherein the DC power supply unit comprises an AC-to-DC converter configured to receive as input the AC voltage and to output the first DC voltage.

9. The telecom base station of claim 1 wherein the baseband unit is coupled to the remote unit by a fiber cable, and the telecommunications signals are communicated between the baseband unit and the remote unit via the fiber cable.

10. The telecom base station of claim 1 wherein all power supplied to the remote unit is provided via the step-down DC transformer.

11. A telecom base station in a telecommunications network comprising:
a. a baseband unit comprising first telecommunications equipment configured for processing telecommunications signals, wherein the first telecommunications equipment is powered by a first DC voltage having a first DC voltage level;
b. a remote unit coupled to the baseband unit and comprising second telecommunications equipment, wherein the second telecommunications equipment is powered by a second DC voltage having a second DC voltage level, further wherein the telecommunications signals are communicated between the first telecommunications equipment and the second telecommunications equipment;
c. an antenna coupled to the remote unit;
d. a DC power supply unit coupled to the baseband unit and configured to receive as input an AC voltage from an AC voltage source external to the telecom base station and to output the first DC voltage;
e. a step-up DC transformer coupled to the DC power supply unit and configured to receive as input the first DC voltage and to output a high DC voltage having a high DC voltage level that is greater than the first DC voltage level and greater than the second DC voltage level; and
f. a step-down DC transformer coupled to the step-up DC transformer and the remote unit, and configured to receive as input the high DC voltage and to output a stepped-down DC voltage having a stepped-down DC voltage level, wherein the remote unit is further configured to receive the stepped-down DC voltage for powering the second telecommunications equipment.

12. The telecom base station of claim 11 wherein the first telecommunications equipment comprises baseband equipment, and the second telecommunications equipment comprises radio equipment.

13. The telecom base station of claim 11 wherein the first telecommunications equipment is a first standardized telecommunications equipment configured to operate at a first standardized DC voltage level, and the second telecommunications equipment is a second standardized telecommunications equipment configured to operate at a second standardized DC voltage level, wherein the first standardized DC voltage level is the first DC voltage level output from the DC power supply unit, and the second standardized DC voltage level is the second DC voltage level.

14. The telecom base station of claim 11 wherein the DC power supply unit comprises a DC battery backup configured to output a backup DC voltage having a backup DC voltage level equal to the first DC voltage level.

15. The telecom base station of claim 11 wherein the DC power supply unit comprises an AC-to-DC converter configured to receive as input the AC voltage and to output the first DC voltage.

16. The telecom base station of claim 11 wherein the first telecommunications equipment is coupled to the second telecommunications equipment by a fiber cable, and the telecommunications signals are communicated between the first telecommunications equipment and the second telecommunications equipment via the fiber cable.

17. The telecom base station of claim 11 wherein all power supplied to the remote unit is provided via the step-down DC transformer.
